(19) United States
(12) Patent Application Publication
(10) Pub. No.: US 2015/0022099 A1
(43) Pub. Date: Jan. 22, 2015

(54) TOUCH ACTIVATED LOW ENERGY APPARATUS FOR ILLUMINATING PERSONAL PORTABLE CARRYING UNITS

(71) Applicants: Joseph Duncanan Farley, Villeneuve Loubet (FR); Chinyere Karen Ngozi Ugoji, Clinton, NJ (US)

(72) Inventors: Joseph Duncanan Farley, Villeneuve Loubet (FR); Chinyere Karen Ngozi Ugoji, Clinton, NJ (US)

(21) Appl. No.: 14/461,371

(22) Filed: Aug. 16, 2014

Related U.S. Application Data
(60) Provisional application No. 61/847,191, filed on Jul. 17, 2013.

(51) Int. Cl. H05B 33/08; H05B 37/02

(52) U.S. Cl. CPC H05B 33/0854; H05B 37/0227; H05B 37/0281
USPC 315/161

(57) ABSTRACT

Embodiments of the present invention are directed to a touch or close proximity activated low energy illumination apparatus. The illumination apparatus are configured to be positioned within personal portable carrying units such as purses, handbags, backpack, shoulder bags, computer bags, bags for communication devices or other container. The illumination apparatus is configured to illuminate inner compartments of such personal portable carrying units. In preferred embodiments, the apparatus is removably attachable to a personal portable carrying unit and can be oriented for the illumination of external objects such as a door lock of a car or building, or the immediate vicinity of a dark space. Certain embodiments may be affixed to or integrated into a personal portable carrying unit. Embodiments of the present invention may comprise a circuit assembly, a power source, at least one semiconductor illuminating device such as a light emitting diode and a plain or decorative pocket. Preferred embodiments provide a pre-programmed timed illumination occurring once the apparatus is touched at the designated touch area; on retouch thereon during the timed period, the illumination immediately switches off giving further battery energy conservation.

### FIELD OF THE INVENTION

The present invention generally relates to illumination apparatus and more specifically to a touch activated low energy illumination apparatus, positioned within personal portable carrying units such as, but not limited to, purses, handbags, backpack, shoulder bags, computer bags, bags of communication devices etcetera, in order to illuminate the inner compartments of such personal portable carrying units. One of ordinary skill in the art would appreciate that there are numerous types of personal portable carrying units that could be used with embodiments of the present invention, and embodiments of the present invention are contemplated for use with any type of personal portable carrying unit. For ease of description in this document, “touch” is used to indicate physical contact with the electrode or placing a body member such as the finger in very close proximity to the electrode.

### BACKGROUND OF THE INVENTION

When a personal portable carrying unit, such as a purse, handbag, a backpack, a computer, the bag of a personal communication device is opened, it may be difficult to see all of its contents. In the art it is known that purse lights are used to illuminate purse contents.

U.S. Pat. No. 6,447,142 issued to Weir describes a purse light system that illuminates the contents when the purse is opened. Separate purse floor compartment that houses the battery power pack, connecting with a fiber optic cable system to transport the light from its source at the floor of the purse to inside of the purse are required; these result in significant loss of the purse's storage capacity, added purse material cost, costly and furthermore complicated purse assembly steps are required, and, illumination of outer purse spaces problematic. This system is not compact and it consumes relatively large operating energies.

U.S. Pat. No. 6,120,162 issued to Guerrieri describes a magnetically actuated purse light system. In this system, alignment between the magnet and the reed switch is always required but this may be difficult for a highly full purse. This system also requires a substantial loss of the purse's storage capacity and costly and complicated purse assembly steps are required. In addition, illumination of outer purse spaces is at best problematic. Furthermore, this system is not compact and it consumes relatively large operating energies.

In the recent years has appeared, purse light switches “touch” activated when a body member, such as the finger, is in contact with the device. U.S. Pat. No. 8,382,309 issued to Johnston describes the Light Pod System. This is an assembly system that is placed within the purse and illuminates when touched. This system also suffers from relatively large energy consumption, a substantial loss of the purse's storage capacity, especially when all of its modules and options are used, and the stainless steel pod may be hidden making touch activation difficult should objects be placed on top of it. Furthermore, setting the adjustable timer beyond a few minutes will quickly discharge the batteries of the power source.

There remains the need in the art for a low energy, compact minimally invasive, portable personal carrying units' light system that can illuminate a plurality of the units' compartments, that can also be used to illuminate nearby external spaces such as the lock of a car door or of a building, that is detachable yet easy to reassemble thereby giving low assembly costs and that is easy to transport to a range of personal portable carrying units. This invention describes such a personal portable carrying units' apparatus that overcomes or improves upon at least one or more deficiencies of the prior art.

### BRIEF SUMMARY OF THE INVENTION

The general purpose of the present invention, which will subsequently be described in more detail, is to provide a touch activated low energy apparatus for illuminating inner and outer spaces of personal portable carrying units and that include many novel features that are not described in prior art illumination devices.

An object of the present invention is to provide a compact, minimally invasive illumination apparatus within a personal carrying unit that enlightens interior spaces for a predefined timed period once the designated touch area of the apparatus is touched.

A further object of the present invention is that the illumination is switched off should a second touch be detected within the predefined time period; this saves energy of power source when illumination is no longer needed and without the need for a switchable illumination duration timer.

A further object of the present invention is that the touch processing detection be implemented by means of a low operating and standby energy application specific integrated device or by a low operating and standby energy microcontroller device adequately programmed to realise the functions specific to this invention.

A further object of the present invention is that the apparatus be compact, low in space volume and of a form such that when mounted, it is minimally invasive within the personal carrying unit.

A further object of the present invention is to provide an illumination apparatus that is simple and easy to use.

A further object of the present invention is to provide an illumination apparatus that is simple easy to mount within the carrying unit.

A further object of the present invention is that the unit can be orientated in three dimensions such as to illuminate its present compartment and other compartments of the personal carrying unit. This capability, unlike that of the fixed illumination systems, further assists detection of small purse objects.

A further object of the present invention is the unit can be orientated to illuminate external spaces to the personal carrying unit, such as to illuminate the lock of a car or building in order to assist the end user in inserting the key, or to illuminate external spaces, for example the immediate vicinity of a dark room.

Yet another object of the present invention is to provide a new personal carrying unit illumination apparatus which may be easily and efficiently manufactured.

Yet another object of the present invention is to provide an illumination apparatus that has low assembly cost and can be easily incorporated in a range of carrying units.

A further object of the present invention is that it can be mounted on a permanent part of the personal carrier unit and be easily removable, for example for examination by airport security personnel or for external illumination.

A further object of the present invention is that its extension into the personal carrying unit is adjustable.

Yet another object of the present invention is to provide a new personal carrying unit illumination apparatus which consumes minimal energy when active and even less energy when not activated thereby requiring infrequent battery changes of periods typically greater than six months, dependant on the number of illuminating light emitting devices (LEDs), the frequency of the end user on-off activations and the electrical capacity of the battery employed.

According to an embodiment of the present invention, an illumination apparatus for use in a personal portable carrying unit includes: a printed circuit board; a touch pad sensing electrode communicatively connected to said printed circuit board; a touch sensor processing integrated circuit communicatively connected to said printed circuit board configured to process interactions with said touch pad sensing electrode; one or more light emitting devices communicatively connected to said printed circuit board; and one or more power sources communicatively connected to said printed circuit board, wherein interactions received upon said touch pad sensing electrode and processed by said touch sensor integrated circuit effect changing a mode of operation of the light emitting devices.

According to an embodiment of the present invention, the illumination apparatus further includes a voltage regulator communicatively connected to said printed circuit board.

According to an embodiment of the present invention, the illumination apparatus further includes one or more resistors communicatively connected to said printed circuit board.

According to an embodiment of the present invention, the illumination apparatus further includes one or more capacitors communicatively connected to said printed circuit board.

According to an embodiment of the present invention, the illumination apparatus further includes an on-off switch communicatively connected to said printed circuit board and configured to change the illumination apparatus into an inoperable state when said on-off switch is placed into an off position.

According to an embodiment of the present invention, the illumination apparatus further includes a secondary surface mounted light emitting device.

According to an embodiment of the present invention, each of said touch pad sensing electrode, said touch sensor processing integrated circuit, said one or more light emitting devices and said one or more power sources are integrated upon said printed circuit board.

According to an embodiment of the present invention, each connection between said touch pad sensing electrode, said touch sensor processing integrated circuit, said one or more light emitting devices said one or more power sources and said printed circuit board are electrical connections.

According to an embodiment of the present invention, the illumination apparatus is configured to operate for up to 6 months on a 1000 mAh 3V coin cell battery, using between 20-40 illumination cycles per week, wherein an illumination cycle is a timed cycle wherein one or more of said one or more light emitting devices are put into an on state for a specific period of time which at the expiration thereof said one or more of said one or more light emitting devices return to an off state.

According to an embodiment of the present invention, the operational mode of the illumination apparatus is a timed cycle wherein one or more of said one or more light emitting devices are put into an on state for a specific period of time which at the expiration thereof said one or more of said one or more light emitting devices return to an off state.

According to an embodiment of the present invention, the surface area of the illumination apparatus is between 1,000-8,000 mm2 and the illumination apparatus has a thickness of less than 10 mm.

According to an embodiment of the present invention, the illumination apparatus further includes a detachable plain or decorative pocket for storing and positioning the illumination apparatus.

According to an embodiment of the present invention, the illumination apparatus further includes a mounting means configured to allow for securing of the illumination apparatus to a personal carrying unit.

According to an embodiment of the present invention, one or more of said one or more light emitting devices are light emitting diodes.

According to an embodiment of the present invention, one or more of said one or more light emitting devices are epoxy lens cased light emitting diodes mounted to the printed circuit board through holes in the printed circuit board.

According to an embodiment of the present invention, an illumination apparatus for use in a personal portable carrying unit includes: a microcontroller; a touch pad sensing electrode communicatively connected to said microcontroller; a touch sensor processing integrated circuit communicatively connected to said microcontroller configured to detect interactions with said touch pad sensing electrode and send information related to said interactions to said microcontroller for processing; one or more light emitting devices communicatively connected to said microcontroller; and one or more power sources communicatively connected to said microcontroller, wherein said interactions processed by said microcontroller effect changing a mode of operation of the light emitting devices.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

The personal portable carrying unit is hereinafter ‘purse’ for ease of description and is not understood as the only application of this invention.

FIG. 1 illustrates one exemplary view of the closed hand purse, specifically described as a clutch bag, showing the location of the light apparatus with respect to this unit, according to the aspects of the present invention.

FIG. 2 illustrates one exemplary view of the opened clutch bag showing the location of the light apparatus and the touch sensitive area with respect to this unit, according to the aspects of the present invention.

FIG. 3 illustrates one exemplary perspective view of an opened three compartment handbag showing of the light apparatus orientated to illuminate the distant compartment with respect to a handbag, according to the aspects of the present invention.

FIG. 4 illustrates one exemplary perspective view of an opened three compartment handbag showing of the light apparatus orientated to illuminate external spaces with respect to a handbag, according to the aspects of the present invention.

FIG. 5 illustrates one exemplary closed perspective view of a closed three compartment wheel bag showing the location of the light apparatus with respect to a wheel bag, according to the aspects of the present invention.

FIG. 6 illustrates one exemplary open perspective view of an opened three compartment wheel bag showing the light apparatus orientated to illuminate the distant compartment with respect to a wheel bag, according to the aspects of the present invention.

FIG. 7 shows an exemplary diagram of the various components of the purse light electrical system according to the aspects of the present invention.

FIG. 8 shows an exemplary electrical circuit diagram for an embodiment of the light apparatus, according to the aspects of the present invention.

FIG. 9a illustrates one exemplary perspective view of insertion of one type of power source, one type of battery holder, the power on off switch and one type of light emitting diodes and their integration onto the printed circuit board (hereinafter PCB), according to the aspects of the present invention.

FIG. 9b illustrates one exemplary components layout view of the PCB (hereinafter PCB top) of the light apparatus, according to the aspects of the present invention.

FIG. 10 illustrates one exemplary view of the opened material for an exemplary pocket of the assembled PCB, showing the touch area and typical openings for the illuminating LEDs, according to the aspects of the present invention.

FIG. 11 illustrates one exemplary view (hereinafter front view) of the closed exemplary pocket of the assembled PCB, showing the touch area and typical openings for the illuminating LEDs, according to the aspects of the present invention.

FIG. 12 illustrates one exemplary rear view (hereinafter rear view) of the closed exemplary pocket of the assembled PCB, showing the back flap with an open close exemplary Velcro fastener that retains the exemplary PCB, according to the aspects of the present invention.

FIG. 13a illustrates direction for insertion of the exemplary PCB assembly into its pocket and showing the position of the touch electrode according to the aspects of the present invention.

FIG. 13b illustrates one exemplary front view of the PCB placed into the pocket formulating the illuminating apparatus, according to the aspects of the present invention.

FIG. 14a illustrates one side section view of an exemplary embodiment for fixed attachment illuminating apparatus showing the PCB, battery and LEDs within the pocket, and vertical attachment section for fixing the apparatus into the carrying unit according to the aspects of the present invention.

FIG. 14b illustrates one bottom section view of an exemplary embodiment showing the enclosed assembled PCB in the pocket of the illuminating apparatus according to the aspects of the present invention.

FIG. 14c illustrates one side section view of an exemplary embodiment for removable illuminating apparatus showing the PCB, battery and LEDs within the pocket, and vertical attachment section to which is attached an exemplary fixing press stud (e.g., metal or plastic snaps) for mating with a press stud within the carrying unit according to the aspects of the present invention.

FIG. 15a illustrates one exemplary view for the removable illumination apparatus consisting a flap or other suitable section of the carrying unit bearing one or more male polarity sections of press studs, according to the aspects of the present invention. Other removable attachment system such as Velcro can be an alternative removable attachment method.

FIG. 15b illustrates one exemplary embodiment for the removable illumination apparatus comprising the PCB within its pocket and the one polarity section of the press studs that can be mated with that on the flap or other area to which is attached the other polarity of press studs of FIG. 15a, according to the aspects of the present invention.

FIG. 16a illustrates one exemplary embodiment for the mounted removable illumination apparatus and the female to male mating of the apparatus' press studs with that of the flap to give an extended illumination extension, according to the aspects of the present invention.

FIG. 16b illustrates one exemplary attachment of the illumination apparatus to the flap secured within the purse, where the female press studs section may be attached to a choice of male complementary press stud sections to alter the illumination extension, and set the range of internal and external orientation, according to the aspects of the present invention.

### DETAILED DESCRIPTION OF THE INVENTION

Hereinafter is a detailed description of an exemplary embodiment of possible embodiments of the personal portable carrying unit's illumination apparatus that enables persons skilled in the art to practice the disclosure and is not intended to limit the scope of the appended claims.

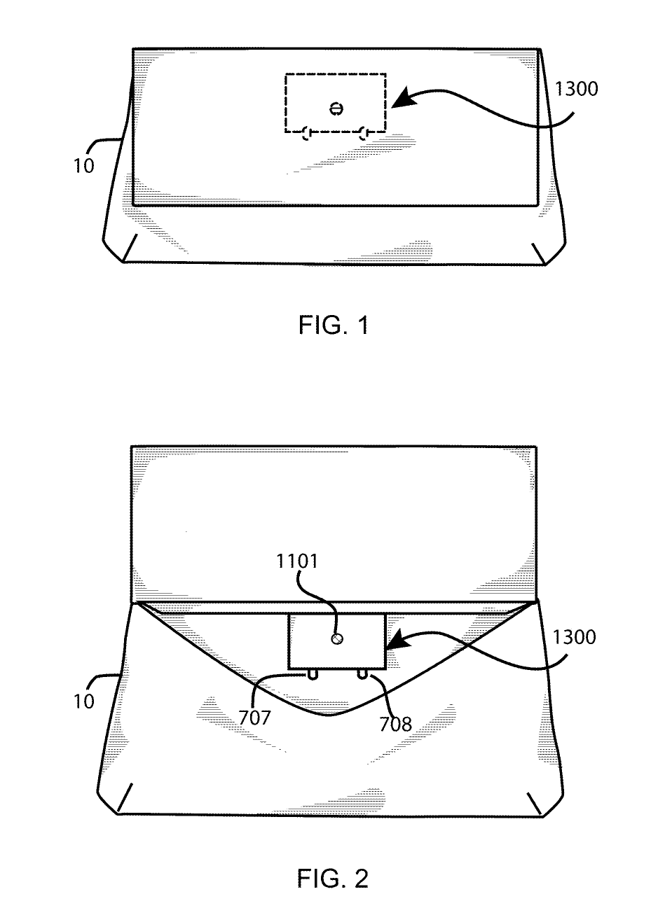

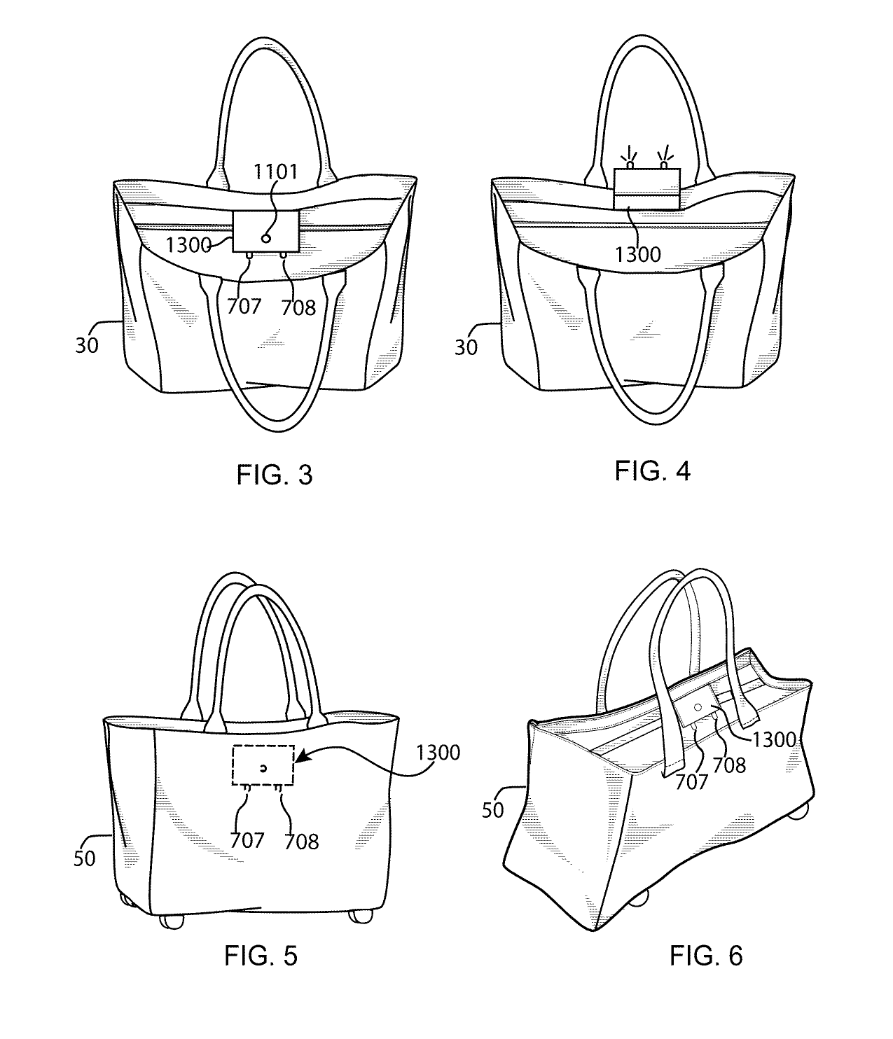

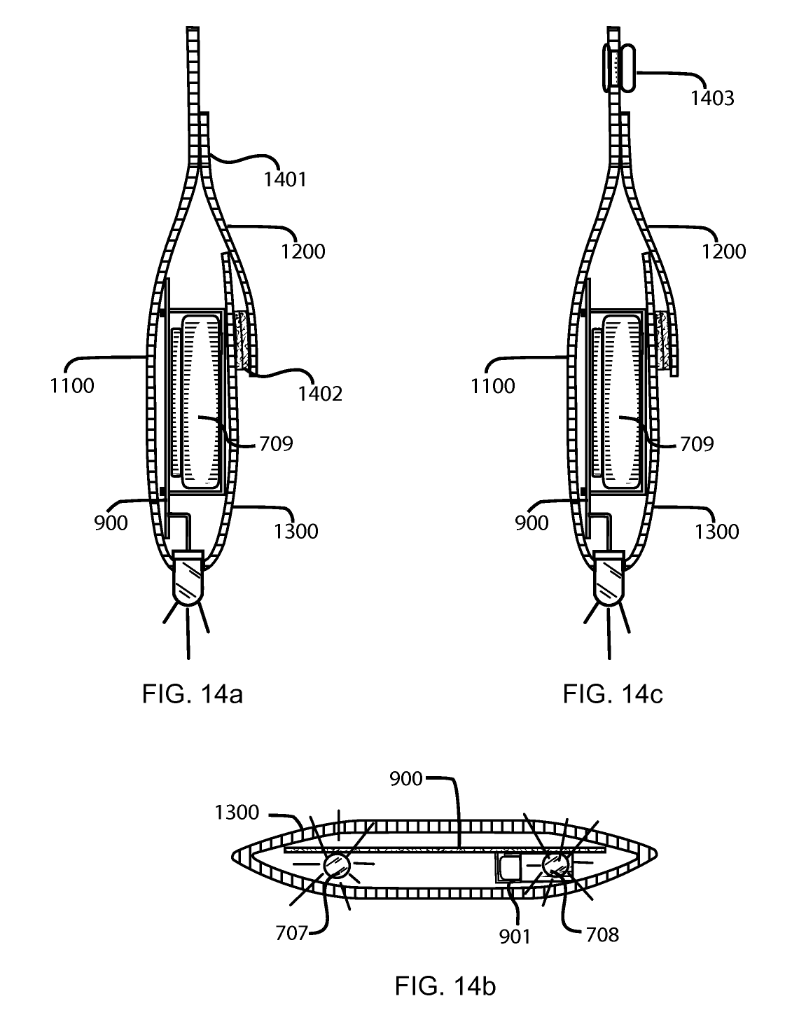

Examples of the present invention assembled into in personal portable carry units are illustrated in FIG. 1 to FIG. 6. FIGS. 14c, 15 and 16 illustrates an example of the preferred embodiment for a removable illumination apparatus version of the present invention and comprises a printed circuit assembly board 900 that is placed into a plain or stylish housing pocket 1504 having a touch area 1101 serving to activate the illumination apparatus, when touched, for a fixed time period and to deactivate (i.e., when a shorter than fixed time period is demanded) the illumination LEDs 707, 708. One of ordinary skill in the art would appreciate that there are numerous types of LEDs that could be utilized with embodiments of the present invention and embodiments of the present invention are contemplated for use with any type of LED.

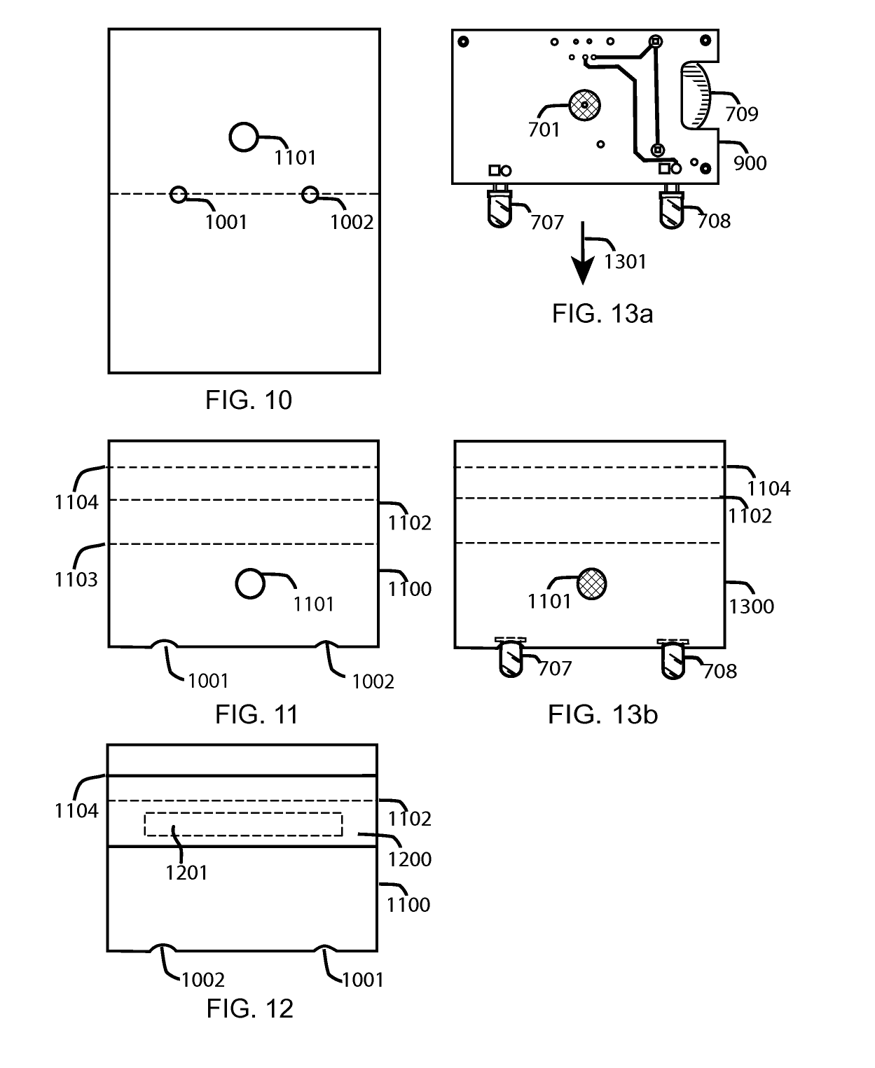

With reference to FIGS. 10 to 14b, an exemplary embodiment of the non-removable version of the present invention and comprises a printed circuit assembly board 900 that is placed into a plain or stylish housing pocket 1300 having a touch area 1101 serving to activate the illumination apparatus, when touched, for a fixed time period and to deactivate (i.e., when a shorter than fixed time period is demanded) the illumination LEDs 707, 708.

Exemplary embodiments of the fixed and removable versions differ only in the fixation system on the holding pocket but share the same assembled electrical unit.

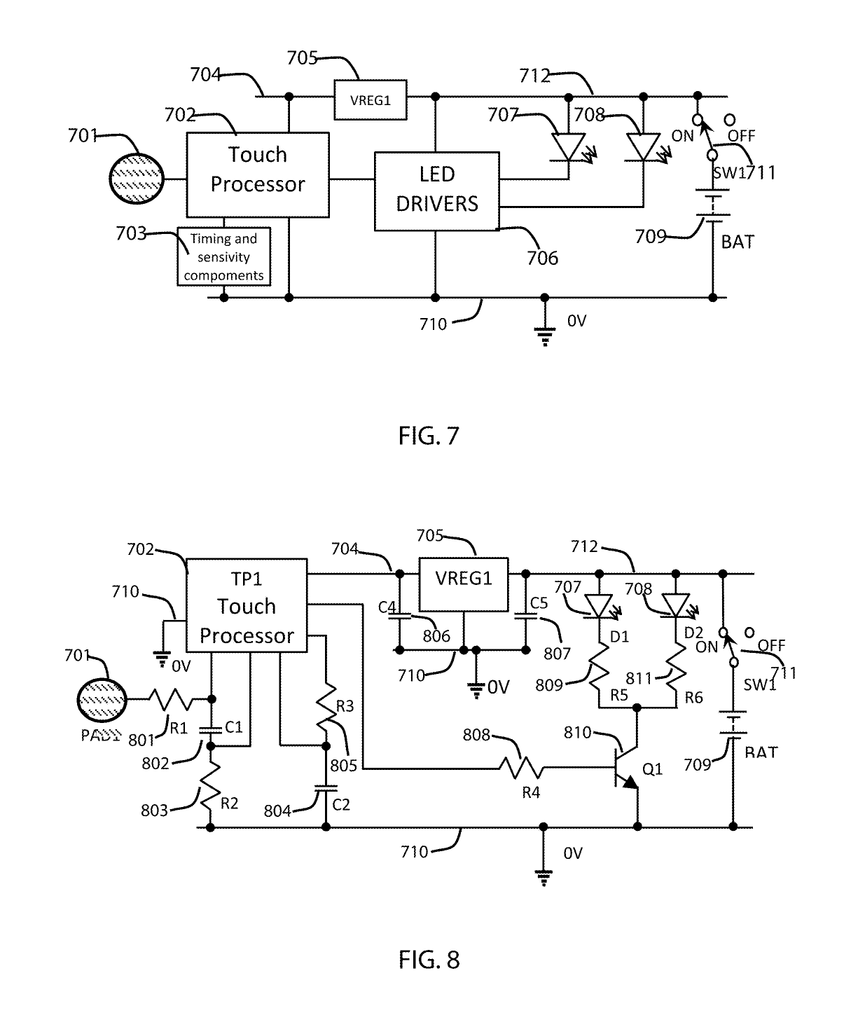

FIG. 7 shows an exemplary diagram of the various components of the personal portable illumination apparatus' electrical system according to the aspects of the present invention. The power source 709 has its negative potential connected to 710 and its positive potential connected through the on-off switch 711 to the input 712 of the optional voltage regulator 705. Use of the voltage regulator permits a wider range of input power source voltages regulated to be within the minimum and maximum operating voltage requirements of the Touch Processor 702. The power source 709 may include one or more primary cells, secondary cells and/or solar cells. The regulator's voltage output 704 is connected to the input voltage supply pin of the Touch Processor circuit 702. The default timed period and touch detection sensitivities are set by the component values in 703, or dependant on the choice of touch processor, this timing may implemented within the software of a microcontroller version of the touch processor. One of ordinary skill in the art would appreciate that there are numerous types of touch processors that could be utilized with embodiments of the present invention, and embodiments of the present invention are contemplated for use with any appropriate touch sensor.

According to a preferred embodiment of the present invention, the touch or proximity detection electrode 701 is connected to the touch detection signal processor device. In an exemplary embodiment, the application specific touch detection integrated circuit is an AT42QT device. LED drivers 706 commanding LEDs 707 and 708 are employed. An alternative circuit embodiment uses a low current microcontroller such as that of Texas Instrument's MSP 430 series which is software programmed and requires neither external timing components nor LED driving components thereby providing a reduction of external components. Yet another alternative circuit embodiment can use low current discrete components to implement the touch processing and LED driving functions. One of ordinary skill in the art would appreciate that there are numerous types of touch or proximity detection electrodes that could be utilized with embodiments of the present invention, and embodiments of the present invention are contemplated for use with any appropriate touch or proximity detection electrode.

With reference to FIG. 8, an exemplary detailed electrical circuit diagram is shown for an embodiment of the illumination apparatus utilising an application specific touch processor AT42QT, according to the aspects of the present invention. The sensitivity components 801, 802 and 803 are chosen as per the manufacturer's AT42QT product specification. Physical electrical contact with the touchpad's electrode 701 is not a necessity; thus, the pad may be covered with a plastic or other suitable material. When the circuit is in its pocket 1300 or 1504, the illumination apparatus may be activated by touching pad area 1101 on the outside of the pocket, and, dependant on the chosen sensitivity components, a physical hole directly over the touchpad's electrode may not be required for illumination activation. The default timing period for the AT42QT is defined by components 804 and 805 and can be chosen to give timed illumination pre-set periods from fractions of a minute to hours (to the detriment of battery life) as defined by the manufacturer's specifications. An alternative embodiment using a microcontroller may not require the use of timing components, instead the microcontroller's programmable timer can be used to realise the timing and control functions. Capacitors 806 and 807 each of typical values of one microfarad serve to assure noise reduction and stability for the MCP1700 voltage regulator 705. The LED driver 810 is a general purpose NPN transistor such as the BC846. This transistor is used in conjunction with the base current limiting resistor 808 and LED current limiting resistors 809 and 811.

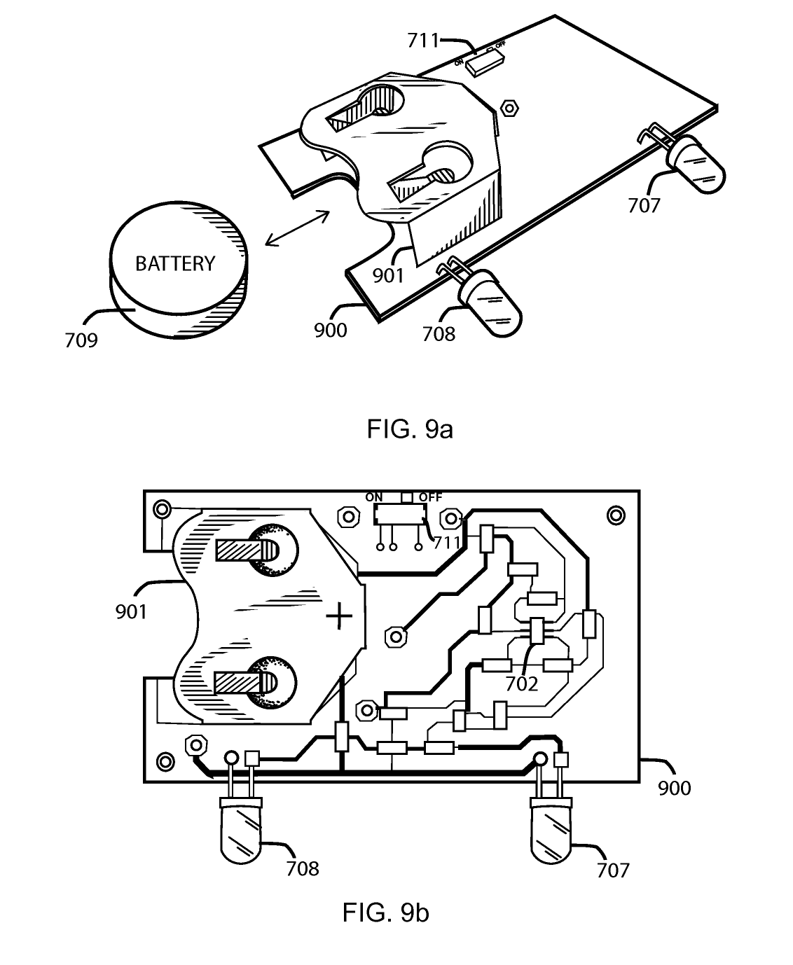

Referencing FIGS. 9a and 9b, the circuit assembly printed circuit board (hereinafter PCB) 900 includes the power cell holder 901, the power supply cell 709, the power on-off switch 711 which can be placed in the off position for energy saving should the personal portable carrying unit be not used in the near term. The holder 901 can be chosen to permit the use of coin cells such as CR2450 or CR2477 or other cells. One of ordinary skill in the art would appreciate that there are numerous types of power supply cells that could be utilized with embodiments of the present invention, and embodiments of the present invention are contemplated for use with any appropriate power supply cell.

According to an embodiment of the present invention, the PCB 900 also includes one form of light emitting diodes 707, 708 and their driving components when required. Another embodiment of the present invention utilizes surface mounted LEDs for lower assembling costs. The PCB 900, FIG. 9b, also includes the integrated circuits, timing and sensitivity resistors, capacitors and the circuit components interconnection means to implement the exemplary electrical circuit embodiment of FIG. 8. The PCB 900 also includes on its second side (herein after top side) the touch pad's electrode 701.

FIG. 10 represents one exemplary view of the raw pocket material that will contain the assembled PCB 900 of the light apparatus according to the aspects of the present invention.

FIG. 11 represents one exemplary front view of pocket that will contain the assembled PCB 900 of the light apparatus, showing the touch area 1101 and the back opening in dotted line 1102, the closing flap 1200 with extremities 1103, 1104 and the LED illumination holes 1001 and 1002 of the present invention.

FIG. 12 represents one exemplary back view of pocket that will contain the assembled PCB 900 of the light apparatus, showing the closing-opening pocket flap 1200 the securing hook and loop area 1201 of the present invention.

FIG. 13a represents one exemplary bottom view of the assembled PCB 900 and arrow 1301 shows its orientation for placement in its pocket 1300.

FIG. 13b represents one exemplary front view of one embodiment of the illumination apparatus of the present invention

FIG. 14a illustrates one exemplary side section view of the attachment of the light apparatus, showing the enclosed assembled PCB 900, the pocket open-close flap 1200 and its attachment to 1100 according to the aspects of the present invention.

FIG. 14b illustrates one exemplary bottom section view of the attachment of the light apparatus, showing the assembled PCB 900 with LEDs 707 and 708 according to the aspects of the present invention.

FIG. 14c illustrates one exemplary side section view of the attachment of the light apparatus, showing the ease of converting between a fixed and removable apparatus; only the addition of the exemplary fastening device such as, but not limited to, a press stud (e.g., metal or plastic snaps) is required to differentiate between the fixed and removable apparatus according to the aspects of the present invention.

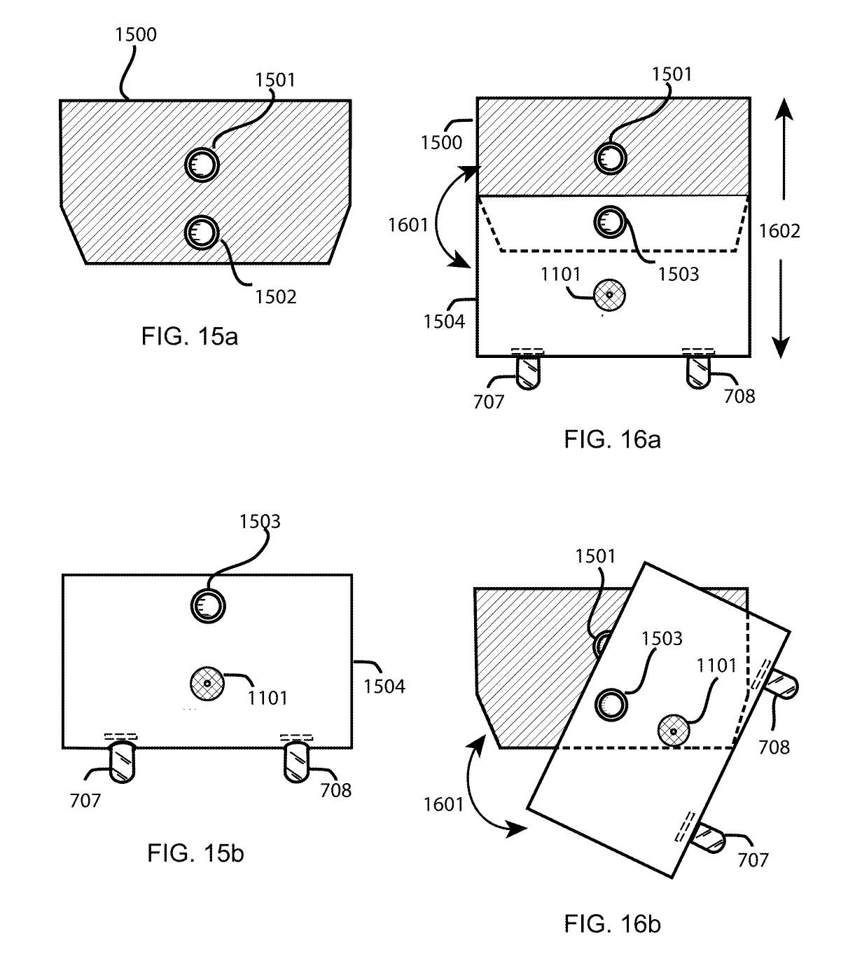

FIG. 15a illustrates one exemplary view of the attachment flap 1500 that is permanently attached within or may be an integral part of the portable carrying unit and that bears one polarity of at least one press studs; two thereof are shown, 1501 and 1502 and are used for illustration purposes according to the aspects of the present invention.

FIG. 15b illustrates one exemplary front view of the light apparatus 1504 with female press-stud 1503 for mating with 1501, or 1502 on permanent attachment 1500 within the portable carrying unit, according to the aspects of the present invention.

FIG. 16a illustrates one exemplary front view of the light apparatus 1504 with the second polarity press-stud 1503 for mating with opposite polarity 1501, or 1502 on attachment 1500 within the portable carrying unit; the length 1602 of the extension is determined by the selection press-stud 1501, 1502 or others for mating with 1503, according to the aspects of the present invention.

FIG. 16b illustrates one exemplary front view of the light apparatus 1504 illustrating an axis of rotation 1601 within the portable carrying unit according to the aspects of the present invention.

It should be understood that, the application of the present invention is not limited to the above examples listed. It will be possible for a person skilled in the art to make modifications or replacements according to the above descriptions, which shall all fall within the protection scope of the appended claims of the present invention.

1. An illumination apparatus for use in a personal portable carrying unit comprising:
a printed circuit board;
a touch pad sensing electrode communicatively connected to said printed circuit board;
a touch sensor processing integrated circuit communicatively connected to said printed circuit board configured to process interactions with said touch pad sensing electrode;
one or more light emitting devices communicatively connected to said printed circuit board; and
one or more power sources communicatively connected to said printed circuit board,
wherein interactions received upon said touch pad sensing electrode and processed by said touch sensor integrated circuit effect changing a mode of operation of the light emitting devices.

2. The illumination apparatus of claim 1, further comprising a voltage regulator communicatively connected to said printed circuit board.

3. The illumination apparatus of claim 1, further comprising one or more resistors communicatively connected to said printed circuit board.

4. The illumination apparatus of claim 1, further comprising one or more capacitors communicatively connected to said printed circuit board.

5. The illumination apparatus of claim 1, further comprising an on-off switch communicatively connected to said printed circuit board and configured to change the illumination apparatus into an inoperable state when said on-off switch is placed into an off position.

6. The illumination apparatus of claim 1, further comprising a secondary surface mounted light emitting device.

7. The illumination apparatus of claim 1, wherein each of said touch pad sensing electrode, said touch sensor processing integrated circuit, said one or more light emitting devices and said one or more power sources are integrated upon said printed circuit board.

8. The illumination apparatus of claim 1, wherein each connection between said touch pad sensing electrode, said touch sensor processing integrated circuit, said one or more light emitting devices said one or more power sources and said printed circuit board are electrical connections.

9. The illumination apparatus of claim 1, wherein the illumination apparatus is configured to operate for up to 6 months on a 1000 mAh 3V coin cell battery, using between 20-40 illumination cycles per week, wherein an illumination cycle is a timed cycle wherein one or more of said one or more light emitting devices are put into an on state for a specific period of time which at the expiration thereof said one or more of said one or more light emitting devices return to an off state.

10. The illumination apparatus of claim 1, wherein said mode of operation comprises a timed cycle wherein one or more of said one or more light emitting devices are put into an on state for a specific period of time which at the expiration thereof said one or more of said one or more light emitting devices return to an off state.

11. The illumination apparatus of claim 1, wherein the surface area of the illumination apparatus is between 1,000-8,000 mm2 and the illumination apparatus has a thickness of less than 10 mm.

12. The illumination apparatus of claim 1, further comprising a detachable plain or decorative pocket for storing and positioning the illumination apparatus.

13. The illumination apparatus of claim 1, further comprising a mounting means configured to allow for securing of the illumination apparatus to a personal carrying unit.

14. The illumination apparatus of claim 1, wherein one or more of said one or more light emitting devices are light emitting diodes.

15. The illumination apparatus of claim 1, wherein one or more of said one or more light emitting devices are epoxy lens cased light emitting diodes mounted to the printed circuit board through holes in the printed circuit board.

16. An illumination apparatus for use in a personal portable carrying unit comprising:
a microcontroller;
a touch pad sensing electrode communicatively connected to said microcontroller;
a touch sensor processing integrated circuit communicatively connected to said microcontroller configured to detect interactions with said touch pad sensing electrode and send information related to said interactions to said microcontroller for processing;
one or more light emitting devices communicatively connected to said microcontroller; and
one or more power sources communicatively connected to said microcontroller,
wherein said interactions processed by said microcontroller effect changing a mode of operation of the light emitting devices.

17. The illumination apparatus of claim 16, further comprising a voltage regulator communicatively connected to said microcontroller.

18. The illumination apparatus of claim 16, further comprising one or more resistors communicatively connected to said microcontroller.

19. The illumination apparatus of claim 16, further comprising one or more capacitors communicatively connected to said microcontroller.

20. The illumination apparatus of claim 16, further comprising an on-off switch communicatively connected to said microcontroller and configured to change the illumination apparatus into an inoperable state when said on-off switch is placed into an off position.

21. The illumination apparatus of claim 16, further comprising a secondary surface mounted light emitting device.

22. The illumination apparatus of claim 16, wherein each connection between said touch pad sensing electrode, said touch sensor processing integrated circuit, said one or more light emitting devices said one or more power sources and said microcontroller are electrical connections.

23. The illumination apparatus of claim 16, wherein the illumination apparatus is configured to operate for up to 6 months on a 1000 mAh 3V coin cell battery, using between 20-40 illumination cycles per week, wherein an illumination cycle is a timed cycle wherein one or more of said one or more light emitting devices are put into an on state for a specific period of time which at the expiration thereof said one or more of said one or more light emitting devices return to an off state.

24. The illumination apparatus of claim 16, wherein said mode of operation comprises a timed cycle wherein one or more of said one or more light emitting devices are put into an on state for a specific period of time which at the expiration thereof said one or more of said one or more light emitting devices return to an off state.

25. The illumination apparatus of claim 16, wherein the surface area of the illumination apparatus is between 1,000-8,000 mm2 and the illumination apparatus has a thickness of less than 10 mm.

26. The illumination apparatus of claim 16, further comprising a detachable plain or decorative pocket for storing and positioning the illumination apparatus.

27. The illumination apparatus of claim 16, further comprising a mounting means configured to allow for securing of the illumination apparatus to a personal carrying unit.

28. The illumination apparatus of claim 16, wherein one or more of said one or more light emitting devices are light emitting diodes.

29. The illumination apparatus of claim 16, wherein one or more of said one or more light emitting devices are epoxy lens cased light emitting diodes mounted to the printed circuit board through holes in the printed circuit board.
